(19) United States
(12) Patent Application Publication
(10) Pub. No.: US 2014/0156066 A1
(43) Pub. Date: Jun. 5, 2014

(54) ELECTRIC HAND WITH A FORCE SENSOR

(71) Applicant: FANUC CORPORATION, Minamitsuru-gun (JP)

(72) Inventor: Tesuro SAKANO, Minamitsuru-gun (JP)

(73) Assignee: FANUC CORPORATION, Minamitsuru-gun (JP)

(21) Appl. No.: 14/091,403

(22) Filed: Nov. 27, 2013

(30) Foreign Application Priority Data
Nov. 30, 2012 (JP) 2012-262861

(51) Int. Cl. B25J 9/16; B25J 15/02; B25J 15/08

(52) U.S. Cl. CPC B25J 9/1612; B25J 15/08; B25J 15/0206; Y10S 901/32
USPC 700/245; 901/32

(57) ABSTRACT

When a gripping instruction is issued, a position feedback control is performed so that an actuator of an electric hand is driven and a finger portion is moved toward a predetermined position target value. When the finger portion comes into contact with a target, the contact is determined by a force sensor. Then, the position feedback control is switched to a force feedback control, and the actuator is driven so that a force detection value obtained by the force sensor matches a predetermined force target value, so that the target may be gripped by an accurate gripping force.

### BACKGROUND OF THE INVENTION

1. Field of the Invention

The present invention relates to an electric hand that has a force sensor installed in a finger portion, and particularly, to an electric hand that has a finger portion opened and closed by an actuator so as to grip a target and has a force sensor installed in the finger portion so as to detect the gripping force.

2. Description of the Related Art

Basically, a robot is used to grip and carry a target, and a hand having a structure in which the target is sandwiched by a plurality of finger portions is generally used to grip the target. If the gripping force of the finger portion is too large when gripping the target by the finger portion, the target is crushed. Meanwhile, if the gripping force is too small, the target is dropped while the target is carried. For this reason, there has been a demand for a hand capable of appropriately adjusting the gripping force of the finger portion in response to the weight or the hardness of the target.

Since the robot needs to perform a next operation such as a carrying operation after the hand gripping operation is completed, a completion signal for checking the completion of the gripping operation is needed. Further, in case where the target can not be gripped since the target does not exist at a specified position, the robot needs to perform an error handling process by stopping a normal operation, and hence an error signal representing a state where the target could not have been gripped is needed.

Japanese Patent Application Laid-Open No. 2011-183513 (JP 2011-183513, A) discloses a gripper-type electric hand that includes a pair of fingers opened and closed by an electric motor, in which a controller controls the gripping force by the current of the motor.

Japanese Patent Application Laid-Open No. 2011-194523 (JP 2011-194523, A) discloses an electric hand in which a direct acting member that moves along a rotation axis driven by a motor is connected with a gripping member in a connection portion in which an elastic member is provided, such that a motor is controlled by detecting the gripping force of the gripping member from a displacement amount of the elastic member.

Robot hands adopting an air cylinder are widely used. The hands can adjust the gripping force by adjusting an air pressure, but the adjustment range of the gripping force is narrow due to the structure of the air cylinder. Further, a proximity switch is generally used to determine whether or not the robot hand normally has gripped the target. For this determination, the proximity switch is installed at an appropriate position of the operation range of the hand, and it is determined whether the target has normally been gripped by using On/Off signals of the proximity switch. In such a determination, the position of the proximity switch needs to be adjusted depending on the size of the target to be gripped in each case.

Robot hands that use an electric motor, instead of an air cylinder, is known. In this case, as disclosed in JP-A 2011-183513, the gripping force of the robot hand is adjusted by adjusting the current of the electric motor. In the method of adjusting the gripping force, a friction of a deceleration mechanism or the like serves as a load of a motor torque. Accordingly, the gripping force to be applied can not be accurate, and the adjustment range of the gripping force may not be largely set.

Meanwhile, as described above, in the electric hand disclosed in JP-A 2011-194523, the gripping force of the gripping member is detected from the displacement amount of the elastic member so as to control the gripping force. It is described that the elastic member is made of rubber or foamed resin. However, since such a material has an elastic modulus that changes according to a temperature and has a large thermal expansion coefficient, so that the detected gripping force is not accurate.

Further, neither JP-A 2011-183513 nor JP-A 2011-194523 describes about the determination as to whether the target gripping operation is completed and the gripping operation has normally been performed.

### SUMMARY OF THE INVENTION

Therefore, an object of the present invention is to provide an electric hand capable of stably gripping a target by an accurate gripping force in a wide gripping force adjustment range, determining whether a target gripping operation is completed or is normally performed, and outputting the determination result as a signal.

In the present invention, a force sensor is provided in a finger portion that grips a target, so that the gripping force may be stably and accurately detected in a wide range. When a gripping instruction is issued, a position feedback control is performed based on a position detection value detected by a position sensor, and an actuator is driven so as to move the finger portion toward a predetermined position target value. When the finger portion comes into contact with the target, a force applied to the finger portion is detected by the force sensor. When it is determined that a force detection value exceeds a predetermined force contact value, the position feedback control is switched to a force feedback control. In the force feedback control, since the actuator is driven so that the force detection value matches a predetermined force target value, the target can be gripped by the accurate gripping force.

When determined that the force detection value reaches the predetermined force target value after switched to the force feedback control, a completion signal representing the completion of the gripping operation is turned on. If the force target value is too small, the force contact value also becomes small. Thus, the contact determination is not easily made, and hence an erroneous operation easily occurs. Further, in the force feedback control, a disadvantageous characteristic is caused in which a response speed is extremely degraded. In such a case, a stable and prompt gripping operation can be realized by moving the finger portion at an appropriate speed according to the position feedback control and promptly stopping the finger portion when the finger portion comes into contact with the target.

The position target value of the position control unit is set to a position exceeding a stop position of the finger portion when the target is gripped. When the target is normally gripped, the finger portion is stopped in front of the position target value. Accordingly, in case where the finger portion reaches the position target value in response to the gripping instruction, it is determined that a state where the target is not normally gripped occurs, whereupon an error signal is turned on.

According to a first aspect of the present invention, there is provided an electric hand with a force sensor which includes: a finger portion that includes a plurality of fingers configured to be opened and closed to grip a target; an actuator that drives the finger portion; at least one force sensor that is provided in the finger portion and detects a force acting in an opening and closing direction of the fingers; a position sensor that detects a movement amount of the finger portion; a driving unit that drives the actuator; a position control unit that performs a position feedback control based on a position detection value from the position sensor when a gripping instruction is issued, and outputs a drive instruction to the driving unit to drive the actuator, thereby moving the finger portion toward a predetermined position target value; a force control unit that performs a force feedback control based on a force detection value from the force sensor and outputs a drive instruction to the driving unit to drive the actuator, thereby driving the actuator so that the force detection value matches a predetermined force target value; a contact determining unit that determines a contact of the finger portion with the target by detecting a state where the force detection value exceeds a predetermined force contact value; and a control switching unit that switches the drive instruction to the driving unit from the position control unit to the force control unit when the contact determining unit determines the contact of the finger portion with the target.

Since the force feedback control is performed based on the force detection value obtained by the force sensor provided in the finger portion, the electric hand can stably and accurately control the gripping force in a wide range. The position control is performed until the target comes into contact with the finger portion, and, when the target comes into contact with the finger portion, control is switched to the force control, as a result, the electric hand can realize a prompt gripping operation.

The electric hand may further include an error determining unit that determines that the target is not gripped when the finger portion reaches the position target value by the position control unit and outputs an error signal. In the electric hand, since the error signal is output when the gripping operation is not normal, the robot can perform an error handling process by interrupting the normal operation based on the error signal.

The electric hand may further include a completion determining unit that determines that the force detection value reaches the force target value when the actuator is driven by the force control unit and outputs a completion signal. Since the electric hand outputs a completion signal representing the completion of the gripping operation, a robot on which the electric hand is mounted will never fails to grip a target, by checking the completion signal.

According to a second aspect of the present invention, there is provided an electric hand with a force sensor which includes: a finger portion that includes a plurality of fingers configured to be opened and closed to grip a target; an actuator that drives the finger portion; at least one force sensor that is provided in the finger portion and detects a force acting in an opening and closing direction of the fingers; a position sensor that detects the movement amount of the finger portion; a driving unit that drives the actuator; a position control unit that performs a position feedback control based on a position detection value from the position sensor when a gripping instruction is issued, and outputs a drive instruction to the driving unit to drive the actuator, thereby moving the finger portion toward a predetermined position target value; a contact determining unit that determines a contact of the finger portion with the target by detecting a state where a force detection value from the force sensor exceeds a predetermined force contact value; and a contact stop unit that outputs a stop instruction to the position control unit to stop the movement of the actuator when the contact determining unit determines the contact of the finger portion with the target, and outputs a completion signal.

Since the electric hand detects a state where the target comes into contact with the finger portion by the force detection value of the force sensor provided in the finger portion, moves the finger portion until the target comes into contact with the finger portion by the position control, and stops the finger portion when detecting the contact state, as a result, a stable and prompt gripping operation can be realized.

The electric hand may further include an error determining unit that determines that the target is not gripped when the finger portion reaches the position target value by the position control unit and outputs an error signal. In the electric hand, since the error signal is output when the gripping operation is not normal, the robot may perform an error handling process by stopping the normal operation based on the error signal.

### BRIEF DESCRIPTION OF THE DRAWINGS

The above-mentioned and other objects and features of the present invention will become clear from the description of the embodiments referring to the accompanying drawings. In these drawings:

FIG. 1 is a schematic configuration diagram illustrating a first embodiment of an electric hand with a force sensor according to the present invention.

FIG. 2 is a schematic configuration diagram illustrating a second embodiment of an electric hand with a force sensor according to the present invention.

FIG. 3 is a diagram illustrating a first example of a control system that controls an actuator of the electric hand with a force sensor according to the present invention to move a finger portion so that the finger is opened or closed.

FIG. 4 is a diagram illustrating a second example of a control system that controls an actuator of the electric hand with a force sensor according to the present invention to move a finger portion so that the finger is opened or closed.

FIG. 5 is a flowchart illustrating a flow of the control of the actuator of the electric hand by the control system illustrated in FIG. 3.

FIG. 6 is a flowchart illustrating a flow of the control of the actuator of the electric hand by the control system illustrated in FIG. 4.

### DETAILED DESCRIPTION OF THE PREFERRED EMBODIMENTS

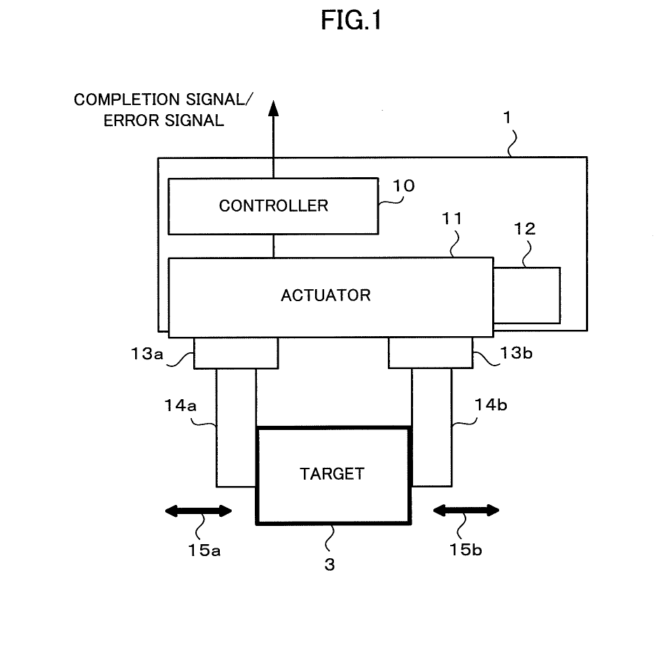

First, a first embodiment of an electric hand with a force sensor according to the present invention will be described with reference to FIG. 1.

An electric hand 1 includes two opening and closing fingers (a finger 14a and a finger 14b). An actuator 11 includes a motor, a decelerator, and a linear driving mechanism, which are not illustrated in the drawings. The decelerator includes a gear or a timing belt, and is used to transmit the rotation of the motor to a linear driving mechanism (not illustrated) while the rotation speed is reduced. The linear driving mechanism is a mechanism that converts the rotation of the motor into a linear operation, and includes a rack and pinion, a feed screw, a nut, a cam mechanism, and a linear mechanism.

The fingers 14a and 14b perform an opening and closing operation while being moved by the linear driving mechanism constituting the actuator 11. The base portions of the fingers 14a and 14b are respectively provided with force sensors 13a and 13b. That is, the fingers 14a and 14b are connected to the linear driving mechanism constituting the actuator 11 through the force sensors 13a and 13b. An arrow 15a of FIG. 1 indicates the movable direction of the finger 14a, and an arrow 15b indicates the movable direction of the finger 14b. The fingers 14a and 14b move (move to be opened and closed) in the directions indicated by the arrows 15a and 15b so as to grip a target 3 in a sandwiched state. When the target 3 has an annular hole or the like, the fingers 14a and 14b are inserted into the hole so as to grip the target 3 in the direction in which the fingers 14a and 14b are opened.

A position sensor 12 is a sensor that detects the movement amount of the actuator 11, and is generally a detector that detects the rotation angle of the motor. Since the fingers 14a and 14b are attached to the force sensors 13a and 13b, it is convenient to exchange the fingers 14a and 14b in response to the shape of the target 3. It is desirable that the force sensors 13a and 13b have function of detecting a force component in a linear axis in the opening and closing direction. A gripping force and a moment are exerted on the base portions of the fingers 14a and 14b. The moment is obtained by multiplying the gripping force by the distance from the base portions of the fingers 14a and 14b to the gripping position. Here, when the lengths of the fingers 14a and 14b are different from each other even at the same gripping force, the moments are different. In order to control the gripping force, it is necessary to detect a force element in the liner axis in the opening and closing direction without coming under the influence of the moment.

A controller 10 controls the electric hand 1 based on a gripping instruction from a robot controller (not illustrated), and performs a target gripping operation. When the target gripping operation is completed, a gripping completion signal is transmitted to the robot controller. Meanwhile, when the target gripping operation is failed, a gripping error signal is transmitted to the robot controller. Note that the controller 10 is not limited to the configuration in which the controller is provided inside the electric hand 1, and may be built in the robot controller (not illustrated).

In FIG. 1, two fingers 14a and 14b are respectively provided with the force sensors 13a and 13b, but since the same gripping force is exerted on the two fingers 14a and 14b in different directions, only one of the finger 14a and 14b may be provided with the force sensor 13a or 13b.

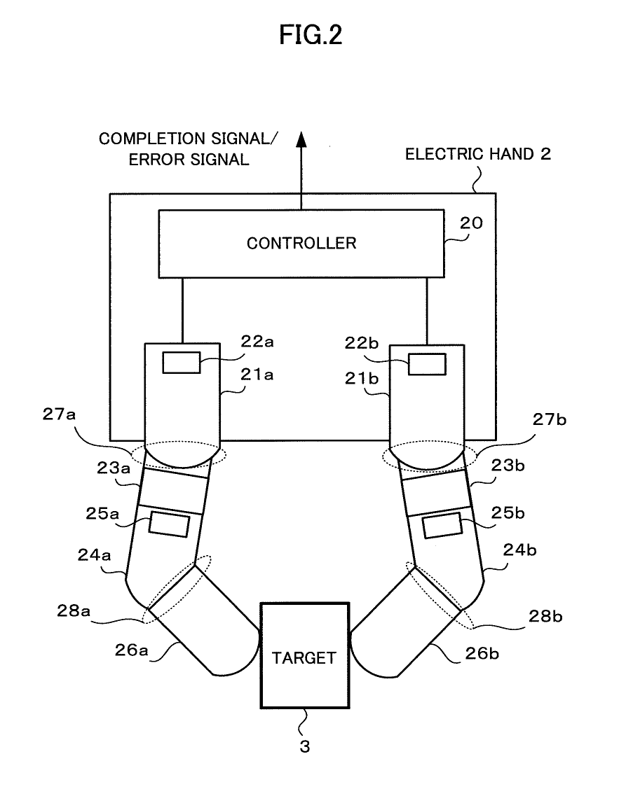

Next, a second embodiment of an electric hand with a force sensor according to the present invention will be described with reference to FIG. 2.

An electric hand 2 includes two fingers (a first finger 26a and a second finger 26b). Each of the first and second fingers 26a and 26b includes two joints. That is, the first finger 26a includes a first joint 27a provided on the base portion side thereof and a second joint 28a provided on the front end side thereof. The second finger 26b includes a first joint 27b provided on the base portion side thereof and a second joint 28b provided on the front end side thereof.

The first joint 27a of the first finger 26a is rotated by a first actuator 21a, and the second joint 28a of the first finger 26a is rotated by a second actuator 24a. The first joint 27b of the second finger 26b is rotated by a first actuator 21b, and the second joint 28b of the second finger 26b is rotated by a second actuator 24b. In this way, the first and second joints 27a and 28a of the first finger 26a and the first and second joints 27b and 28b of the second finger 26b are rotated by the first and second actuators 21a and 24a of the first finger 26a and the first and second actuators 21b and 24b of the second finger 26b, so that the target 3 is gripped while being sandwiched between the front ends of the first and second fingers 26a and 26b provided in the electric hand 2.

The first and second actuators 21a and 24a of the first finger 26a and the first and second actuators 21b and 24b of the second finger 26b respectively include position sensors (rotation angle sensors 22a, 25a, 22b, and 25b), and are configured to detect the rotation states of the joints.

Further, a first force sensor 23a is provided between the first joint 27a and the second joint 28a of the first finger 26a, and a second force sensor 23b is provided between the first joint 27b and the second joint 28b of the second finger 26b. The first and second force sensors 23a and 23b detect moment components acting on the first joints 27a and 27b of the first and second fingers 26a and 26b. In this case, the gripping force of the target 3 can not be directly detected by only the outputs of the first and second force sensors 23a and 23b, but can be obtained by the calculation using the output values of the first and second force sensors 23a and 23b, the lengths of the first and second fingers 26a and 26b, and the angles of the first joints 27a and 27b and the angles of the second joints 28a and 28b.

The operation of the electric hand 2 is controlled by the controller 20. The controller 20 causes the electric hand 2 to perform the target gripping operation based on a gripping instruction from the robot controller (not illustrated). Then, when the target gripping operation is completed, a gripping completion signal is transmitted to the robot controller. Meanwhile, when the target gripping operation is failed, an error signal is transmitted to the robot controller. Note that the controller 20 is not limited to the configuration in which the controller is provided inside the electric hand 2, and may be built in the robot controller.

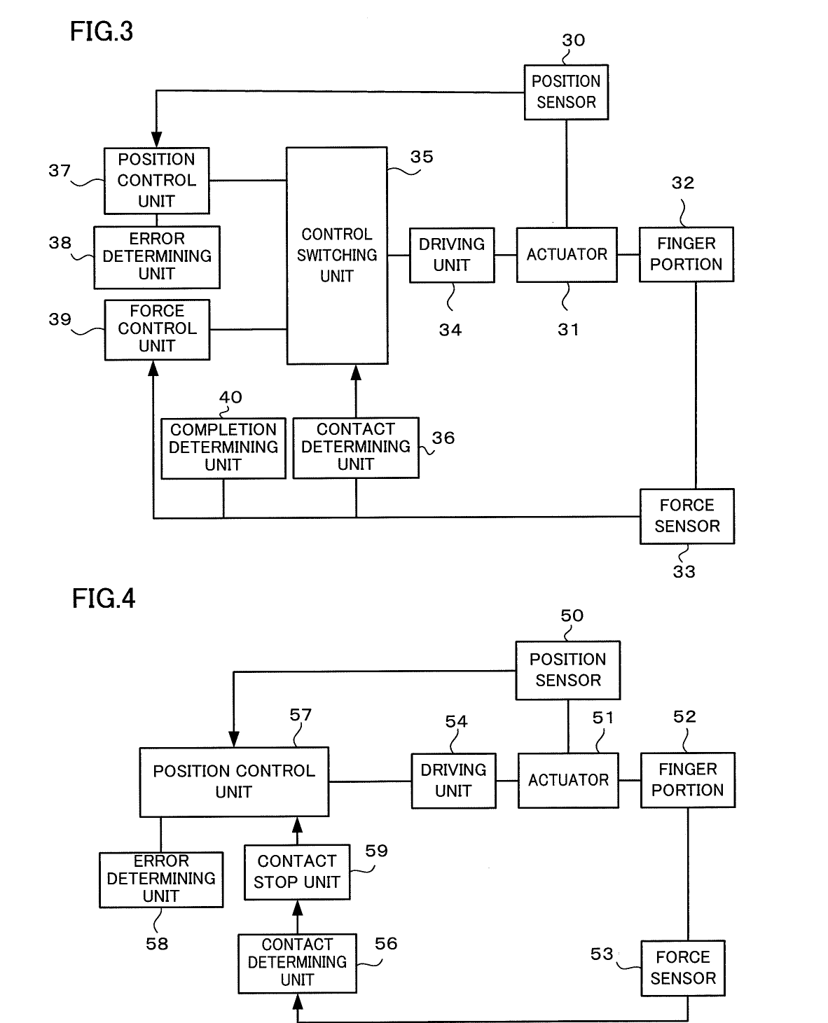

A first example of a control system that controls the actuator of the electric hand to move a finger portion so that the finger is opened or closed will be described with reference to FIG. 3.

In FIG. 3, a finger portion 32 includes the fingers 14a and 14b (FIG. 1) and the fingers 26a and 26b (FIG. 2) that come into contact with the target 3 (see FIGS. 1 and 2) and further includes a mechanism (for example, a rack or a gear) that causes the fingers 14a and 14b and the fingers 26a and 26b to be driven by the actuator 31.

The movement amount of the finger portion 32 is detected by a position sensor 30, and the gripping force acting on the finger portion 32 is detected by the force sensor 33. The actuator 31 has a motor (not illustrated) embedded therein, and the motor is driven by a driving unit 34. The driving unit 34 is specifically an amplifier.

A position control unit 37 is used to update an instruction position and perform a position feedback control. As the updating of the instruction position, a new instruction position is calculated by adding a movement amount every unit period, for example, 4 mill seconds. Then, when the instruction position reaches a target position, the adding of the movement amount is stopped, and the adding of the movement amount to the instruction position is carried out so that the instruction position matches the target position. The position control unit 37 performs a position feedback control so that the detection position of the position sensor 30 follows the instruction position, and outputs a drive instruction to the driving unit 34 so that the rotation of the motor built in the actuator 31 is controlled.

A force control unit 39 outputs a drive instruction to the driving unit 34, by performing a force feedback control so that the force detection value follows the force target value, thereby controlling the rotation of the motor (not illustrated) built in the actuator 31. A contact determining unit 36 monitors the force detection value, and determines that the fingers of the finger portion 32 come into contact with the target when the force detection value becomes a predetermined force contact value or more.

Even when no force is acting on the force sensor 33, there is a case that the read value from the force sensor 33 is not zero, and the read value in this case is called an offset. When the fingers of the finger portion 32 do not grip anything, the read value from the force sensor 33 is stored as an offset. Then, a value obtained by subtracting the value stored as the offset from the read value of the force sensor 33 is referred to as the “force detection value”. In this way, the force detection value is not the read value of the force sensor 33 but a value representing the external force acting on the force sensor 33.

When it is determined that the fingers of the finger portion 32 come into contact with the target to be gripped, a control switching unit 35 switches the drive instruction to the driving unit 34 from the position control unit 37 to the force control unit 39. In the force feedback control, when a force gain of a feedback loop is increased, the control easily becomes instable, and hence the force gain can not be increased any more. Generally, in the force feedback control, the actuator is driven with a speed instruction obtained by multiplying the force gain by the force deviation amount obtained by subtracting the force detection value from the force target value. When the motor is driven by the force control unit 39 when the fingers are not in contact with the target to be gripped, the movement speed is low as the force gain is small and the speed instruction is small. Further, since the speed is determined depending on the force target value, the movement speed becomes extremely low when the force target value is small. Accordingly, there is a drawback that it takes time until the fingers reach the contact position.

Meanwhile, when the fingers are in contact with the target to be gripped, the fingers and the target to be gripped are bent as the fingers move. The bent amount is proportional to the gripping force, and in general, the gripping force increases by a slight bent amount. Since the gripping force increases by a slight rotation of the motor after the fingers come into contact with the target to be gripped (in other words, by a slight finger movement) the gripping operation can be completed in a short time by causing the force detection value to reach the force target value by the force control unit 39. Therefore, it is very advantageous to drive the motor by means of the position control unit 37 so as to move the fingers at a fast speed when the fingers are not in contact with the target to be gripped and to drive the motor by means of the force control unit 39 by switching to the force control unit 39 when it is determined that the fingers come into contact with the target to be gripped. By this method, the entire gripping operation can be promptly performed in a short time.

The completion determining unit 40 determines whether the force detection value reaches the force target value by the force control unit 39, and turns on the gripping completion signal if determining that the force detection value reaches the force target. If the robot is configured not to move for the next operation until it checks this signal, it is possible to prevent the robot from moving while gripping the target and dropping the target, or stopping for a certain time even after the target gripping operation is completed and wasting a time.

When the target to be gripped does not exist, the fingers of the finger portion 32 are moved to the target position and are stopped at the target position by the position control unit 37. The target position is set to a position which exceeds the position where the target to be gripped is gripped. When the target to be gripped is normally gripped, the fingers are stopped in front of the target position, but when the target to be gripped is not gripped, the fingers are stopped after reaching the target position. The error determining unit 38 determines this state, and turns on the error signal when the target to be gripped can not be normally gripped. The robot can interrupt a normal operation and perform an error handling process by checking this signal.

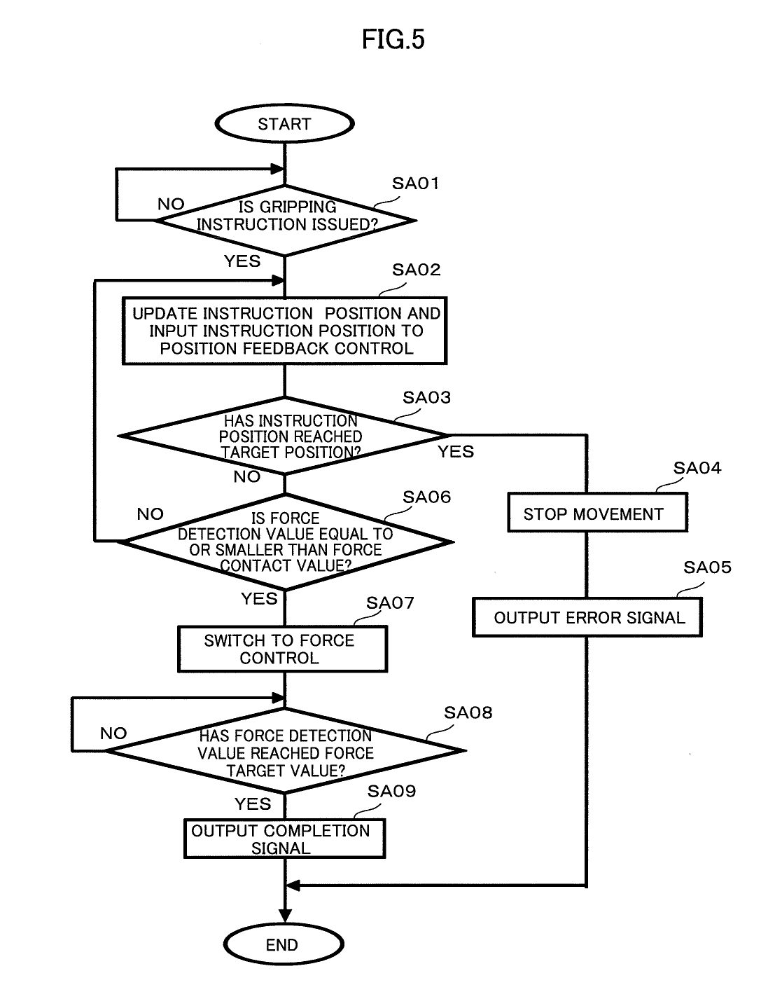

A second example of a control system that controls the actuator of the electric hand so that the finger portion is moved to be opened or closed will be described with reference to FIG. 4.

The control system illustrated in FIG. 4 is different from the control system illustrated in FIG. 3 in that the force control unit 39 is not provided but a contact stop unit 59 is additionally provided.

When the contact determining unit 56 determines that the fingers of the finger portion 52 come into contact with the target to be gripped, the contact stop unit 59 outputs a prompt movement stop instruction to the position control unit 57, and turns on the gripping completion signal.

In the method of switching the drive instruction to the driving unit 34 from the position control unit 37 to the force control unit 39 when the control system of FIG. 3 determines that the fingers of the finger portion 32 come into contact with the target to be gripped, the force contact value is generally set to a value that is smaller than the force target value, for example, a value of about 20% of the force target value. Then, since the position control is switched to the force control at an early point of time, the response of the force feedback control becomes smooth, and the gripping force reaches the force target value without a large overshoot. However, when the force target value is very small, the force contact value further becomes small. Thus, an erroneous operation may easily occur in which the contact state is erroneously determined due to the force detection value exceeding the force contact value due to a vibration or a variation in detection. Further, the movement speed of the motor becomes slow in the force feedback control, and hence the response time becomes long.

On the contrary, in the control system of FIG. 4, the force contact value is set to a value close to the force target value, so that an erroneous contact determination operation in the contact stop unit 59 can be prevented, and an appropriate speed can be designated by the position control unit 57. This method is particularly useful in a case where the target to be gripped is soft.

Several methods of promptly stopping the movement of the fingers by the contact stop unit 59 will be described below.

(a) An instruction position input to the position feedback control is stopped. According to this method, an amount of coasting until the motor built in the actuator 51 actually stops become large. Generally, in the position feedback control, a value obtained by multiplying a position gain by a positional deviation amount obtained by subtracting the detection position from the instruction position becomes a movement speed, and when the instruction position input is stopped, the positional deviation amount at this time becomes an amount of coasting.

(b) A motor driving voltage is set to zero. In this method, an amount of coasting until the motor built in the actuator 51 is actually stopped becomes very small, but does not become zero.

(c) The positional deviation amount is once cleared to zero, and then the normal position feedback control is performed. Since this method can finally stop the motor at the position where the contact is determined, the amount of coasting becomes zero. Alternatively, an appropriate amount of coasting is once set, instead of setting the positional deviation amount to zero, and then the normal position feedback control is performed. With this, the motor finally stops at the position where the amount of coasting is added to the position where the contact is determined. The smaller the amount of casting until the motor stops is, the larger the acceleration in the deceleration direction is, so that the deceleration shock and the load applied to the actuator increase. In general, an appropriate stop method is employed according to a tolerable degree of the actuator.

The flow of the control of the actuator of the electric hand by the control system illustrated in FIG. 3 will be described by the use of the flowchart of FIG. 5.

When the gripping instruction is issued, a movement amount is added every unit period so that the instruction position is updated and the instruction position is input to the position feedback control. When the instruction position has not reached the target position yet, the instruction position is updated if the force detection value is smaller than the force contact value. Meanwhile, if the force detection value is equal to or larger than the force contact value, it is considered that the fingers come into contact with the target to be gripped, and hence the position feedback control is switched to the force feedback control. In the force control, the feedback control is performed so as to follow the force target value and waits until the force detection value reaches the force target value. Then, when the force detection value reaches the force target value, the gripping completion signal is turned on, and the operation in response to the gripping instruction is ended. Meanwhile, when the fingers reach the target position while the instruction position is updated, the opening and closing movement of the fingers is stopped, determining that the target to be gripped failed to be normally gripped, so that the error signal is turned on and the operation in response to the gripping instruction is ended.

Here, the respective steps in the flowchart will be described below.

[step SA01] It is determined whether the gripping instruction is issued or not. When the gripping instruction is issued (YES), the process proceeds to step SA02. When the gripping instruction is not issued (NO), on the other hand, the process waits until the gripping instruction is issued.

[step SA02] The movement amount is added every unit period to update the instruction position, and the updated instruction position is input to the position feedback control.

[step SA03] It is determined whether the instruction position reaches the target position or not. When the instruction position reaches the target position (YES), the process proceeds to step SA04. When the instruction position does not reach the target position (NO), on the other hand, the process proceeds to step SA06.

[step SA04] The movement of the motor built in the actuator 31 is stopped, assuming that the motor reached the instruction position at this stage because the target to be gripped did not exist. Then, the instruction position is made to match the target position, and the motor is stopped at the target position by the position feedback control.

[step SA05] An error signal is turned on, and the operation in response to the gripping instruction is ended.

[step SA06] When the force detection value is smaller than the force contact value (NO), the process returns to step SA02 and updates the instruction position, assuming that the fingers have not come into contact with the target yet. When the force detection value becomes equal to or larger than the force contact value (YES), on the other hand, the process proceeds to step SA07, assuming that the fingers have come into contact with the target.

[step SA07] The position feedback control is switched to the force feedback control.

[step SA08] It is determined whether the force detection value reaches the force target value or not. When the force detection value reaches the force target value (YES), the process proceeds to step SA09. When the force detection value does not reach the force target value (NO), on the other hand, the process waits until the force detection value becomes equal to or larger than the force target value, and then the process proceeds to step SA09.

[step SA09] The completion signal is turned on, and the operation in response to the gripping instruction is ended.

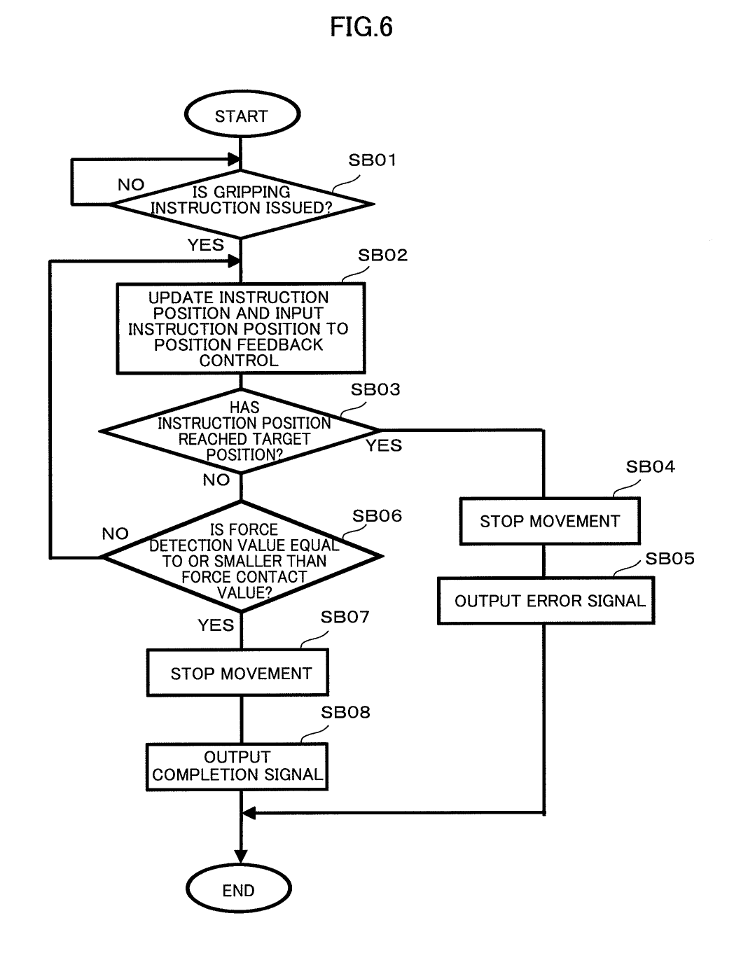

The flow of the control of the actuator of the electric hand by the control system illustrated in FIG. 4 will be described below by using the flowchart of FIG. 6.

In the flowchart of FIG. 5, control is switched to the force feedback control when the force detection value becomes equal to or larger than the force contact value (SA06). However, in the flowchart of FIG. 6, the movement of the motor of the actuator is stopped (SB07) when the force detection value becomes equal to or larger than the force contact value (SB06), and this point is different from the flowchart of FIG. 5. As there are several method of stopping the movement of the motor, as described, an appropriate method can be selected among them.

Hereinafter, the respective steps in the flowchart will be described below.

[step SB01] It is determined whether the gripping instruction is issued or not. When the gripping instruction is issued (YES), the process proceeds to step SB02. When the gripping instruction is not issued (NO), on the other hand, the process waits until the gripping instruction is issued.

[step SB02] The movement amount is added every unit period to update the instruction position, and the updated instruction position is input to the position feedback control.

[step SB03] It is determined whether the instruction position reaches the target position or not. When the instruction position reaches the target position (YES), the process proceeds to step SB04. When the instruction position does not reach the target position (NO), on the other hand, the process proceeds to step SB06.

[step SB04] The movement of the motor built in the actuator 51 is stopped, assuming that the motor reached the instruction position at this stage because the target to be gripped did not exist. Then, the instruction position is made to match the target position, and the motor is stopped at the target position by the position feedback control.

[step SB05] An error signal is turned on, and the operation in response to the gripping instruction is ended.

[step SB06] When the force detection value is smaller than the force contact value (NO), the process returns to step SB02 and updates the instruction position, assuming that the fingers have not come into contact with the target yet. When the force detection value becomes equal to or larger than the force contact value (YES), on the other hand, the process proceeds to step SB07, assuming that the fingers have come into contact with the target.

[step SB07] The driving of the motor is stopped.

[step SB08] The completion signal is turned on, and the operation in response to the gripping instruction is ended.

The processes of the flowcharts of FIGS. 5 and 6 are performed by the controller 10 of FIG. 1 or the controller 20 of FIG. 2. The processes of FIGS. 5 and FIG. 6 can be performed by storing the data of the target position, the force contact value, and the force target value in advance in the memory of the controller 10 or the controller 20.

1. An electric hand comprising:
a finger portion that includes a plurality of fingers configured to be opened and closed to grip a target;
an actuator that drives the finger portion;
at least one force sensor that is provided in the finger portion and detects a force acting in an opening and closing direction of the fingers;
a position sensor that detects a movement amount of the finger portion;
a driving unit that drives the actuator;
a position control unit that performs a position feedback control based on a position detection value from the position sensor when a gripping instruction is issued, and outputs a drive instruction to the driving unit to drive the actuator, thereby moving the finger portion toward a predetermined position target value;
a force control unit that performs a force feedback control based on a force detection value from the force sensor and outputs a drive instruction to the driving unit to drive the actuator, thereby driving the actuator so that the force detection value matches a predetermined force target value;
a contact determining unit that determines a contact of the finger portion with the target by detecting a state where the force detection value exceeds a predetermined force contact value; and
a control switching unit that switches the drive instruction to the driving unit from the position control unit to the force control unit when the contact determining unit determines the contact of the finger portion with the target.

2. The electric hand according to claim 1, further comprising an error determining unit that determines that the target is not gripped when the finger portion reaches the position target value by the position control unit and outputs an error signal.

3. The electric hand according to claim 1, further comprising a completion determining unit that determines that the force detection value reaches the force target value when the actuator is driven by the force control unit and outputs a completion signal.

4. An electric hand comprising:
a finger portion that includes a plurality of fingers configured to be opened and closed to grip a target;
an actuator that drives the finger portion;
at least one force sensor that is provided in the finger portion and detects a force acting in an opening and closing direction of the fingers;
a position sensor that detects the movement amount of the finger portion;
a driving unit that drives the actuator;
a position control unit that performs a position feedback control based on a position detection value from the position sensor when a gripping instruction is issued, and outputs a drive instruction to the driving unit to drive the actuator, thereby moving the finger portion toward a predetermined position target value;
a contact determining unit that determines a contact of the finger portion with the target by detecting a state where a force detection value from the force sensor exceeds a predetermined force contact value; and
a contact stop unit that outputs a stop instruction to the position control unit to stop the movement of the actuator when the contact determining unit determines the contact of the finger portion with the target, and outputs a completion signal.

5. The electric hand according to claim 4, further comprising an error determining unit that determines that the target is not gripped when the finger portion reaches the position target value by the position control unit and outputs an error signal.
